(19) United States
(12) Patent Application Publication
(10) Pub. No.: US 2008/0295285 A1
(43) Pub. Date: Dec. 4, 2008

(54) HINGE PIN FOR ENCLOSURE

(75) Inventors: Joshua Daniel Clymer, St. Cloud, MN (US); David Lee Schaefbauer, Champlin, MN (US); Marcus Adrian Koukkari, Minneapolis, MN (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(73) Assignee: Hoffman Enclosures, Inc, Anoka, MN (US)

(21) Appl. No.: 11/756,380

(22) Filed: May 31, 2007

(51) Int. Cl. E05D 7/10; E05D 11/00

(52) U.S. Cl. 16/223; 16/229

(57) ABSTRACT

A hinge pin for use with a hinge section having a bore. The hinge pin includes a hinge pin body dimensioned to fit within a bore of a hinge section and a clip having a first end attached to the hinge pin body, the clip extending along the hinge pin body and configured to be located outside the hinge section when the hinge pin body is within the bore.

### FIELD OF THE INVENTION

This invention relates to the field of electrical enclosures, and more specifically to a hinge pin for an enclosure.

### BACKGROUND

Electrical enclosures can be used to house assorted electrical and datacom equipment. The enclosure protects the electrical equipment from the environment and helps prevent access to the equipment. An enclosure typically includes a door hinged to the enclosure. For example, the door and the enclosure body each include hinge sections and are coupled together using a hinge pin located within the hinge sections. The installer or user typically needs to use tools to mount and/or remove the hinge pin to install or remove the door. Also, some enclosures have doors that are designed to be opened either right-handed or left-handed and the installer or user may need to change the door orientation.

### SUMMARY

A hinge pin includes a hinge pin body dimensioned to fit within a bore of a hinge section and a clip having a first end attached to the hinge pin body, the clip extending along the hinge pin body and configured to be located outside the hinge section when the hinge pin body is within the bore.

### BRIEF DESCRIPTION OF THE DRAWINGS

FIG. 1 shows a perspective view of an enclosure according to one embodiment.

FIG. 2 shows an exploded view of a hinge for an enclosure, in accordance with one embodiment.

FIG. 3 shows another view of the hinge of FIG. 2.

FIG. 4 shows a perspective view of a hinge pin, in accordance with one embodiment.

FIG. 5 shows a side view of the hinge pin of FIG. 4.

FIG. 6 shows an end view of the hinge pin of FIG. 4.

FIG. 7 shows a side view of a hinge pin in accordance with one embodiment.

FIG. 8 shows an end view of the hinge pin of FIG. 7.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

FIG. 1 shows a perspective view of an enclosure 100 according to one embodiment. Enclosure 100 includes an enclosure body 110 and a front opening 115. A front door 130 is mountable to enclosure body 110. In this example, enclosure body 110 includes hinge sections 120, 121 mounted on the left side of opening 115. Door 130 includes hinge sections 132, 134, 136, and 138 mounted to a side of the door. Hinge sections 120, 121 of enclosure body mount to hinge sections 132, 134, 136, and 138 of door 130 and are held together by a hinge pin (described below), allowing the door to rotate relative to the enclosure.

In one embodiment, the enclosure can further include hinge sections 122, 123 mounted to a right side of opening 115. This allows door 130 to be mounted to either side of opening 115 so as to be able to open either from the left or from the right. In some examples, there is a gasket material around opening 115 or on the inside of door 130, or both.

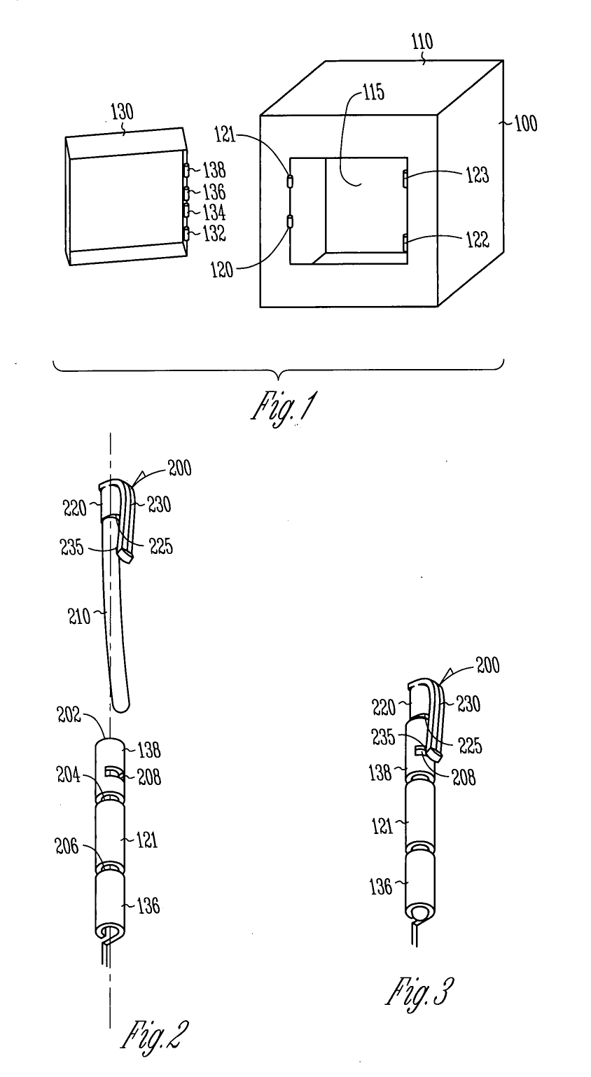

FIG. 2 shows an exploded view of the hinge of enclosure 100, in accordance with one embodiment. Hinge sections 138 and 136 of door 130 (FIG. 1) and hinge section 121 of enclosure body 110 (FIG. 1), are shown. Each hinge section 138, 121, and 136 includes a generally tube shaped body having a hinge bore 202, 204, 206, respectively. The hinge sections are aligned relative to each other such the bores 202, 204, and 206 are substantially co-linear. In one embodiment, at least one of the door hinge sections 138 includes a slot 208 at least partially through the wall of the hinge section. A tool-less removable hinge pin 200 is provided to hold hinge sections 138, 121, and 136 together.

In one embodiment, hinge pin 200 generally includes a pin body 210 with a head portion 220 on one end. Head portion 220 includes a shoulder 225. A clip 230 is attached to hinge pin body 210. Clip 230 includes a first end mounted to the hinge pin body 210. Clip 230 extends along hinge body 210 from head portion 220 to a free end of the clip. The clip 230 includes a protrusion 235 on the free end of the clip 230. Hinge pin body 210 is dimensioned to slidably fit within the bores of the hinge sections.

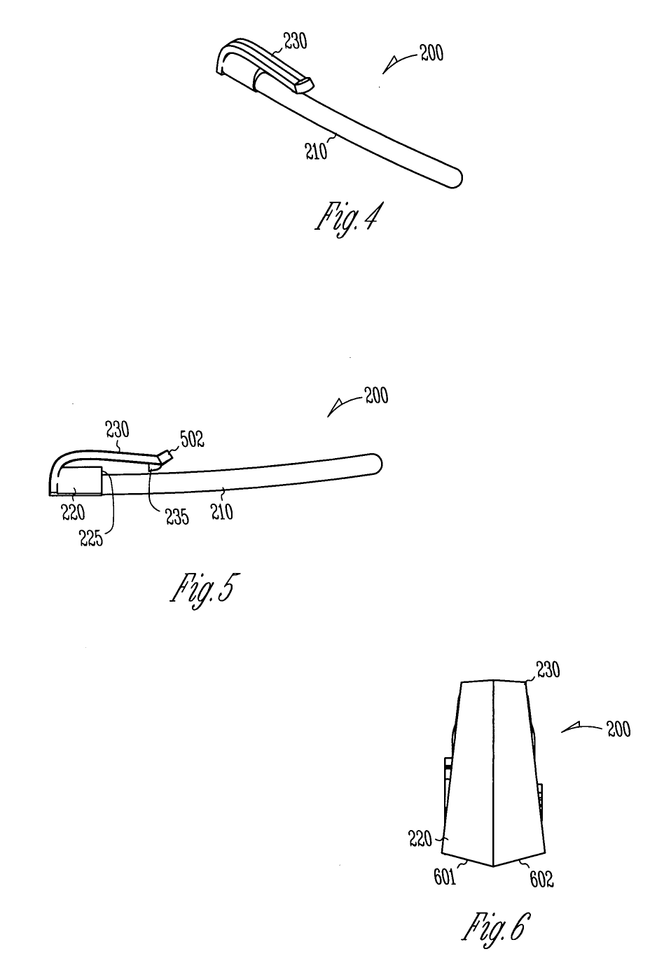

Referring now also to FIG. 3, which shows the hinge with hinge pin 200 mounted with the hinge bores of hinge sections 121, 136, and 138. When properly mounted, shoulder 225 of pin 200 rests on an upper surface of hinge section 238 and clip 230 is on the outside of the hinge section with protrusion 235 engaged with slot 208. Slot 208 helps to hold the pin 200 in place and restricts it from rotating too much when the pin is within the hinge bores. If the hinge pin 200 did spin around, clip 230 might cause damage to a gasket of the enclosure or not allow the door to close. In one embodiment, hinge pin body 210 has a slightly curved shape. This curved shape allows the hinge pin body 210 to contact opposing inner wall surfaces of the hinge sections so as to help hold hinge pin 200 within the hinge bores.

FIGS. 4 and 5 show further details of hinge pin 200. FIG. 4 shows a perspective view of hinge pin 200 and FIG. 5 shows a side view of the hinge pin. In one embodiment, hinge pin 200 can be formed by an injection molded process, for example. Referring to FIG. 5, the free end of clip 230, past protrusion 235, includes a tab 502. A user can get their finger under tab 502 to raise up the clip and remove protrusion 235 from slot 208 (FIG. 3), thus allowing for the release the pin 200 from a hinge. This configuration allows the hinge pin 200 to be removed without the use of any tools. This can lead to a significant reduction in assembly labor time. Moreover, there is enhanced ease of use and reliability for the end user if they want to reverse the door, for example.

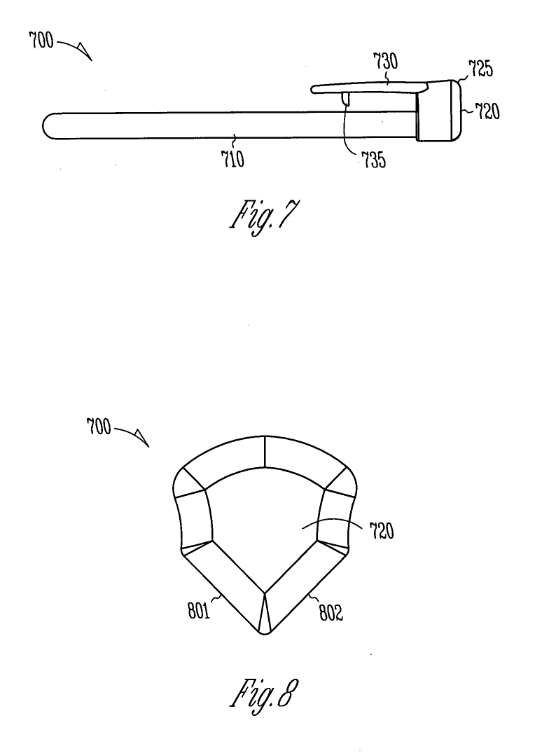

FIG. 6 shows an end view of the hinge pin 200. In one embodiment, the cross section of head portion 220 includes two angled front edges 601 and 602. The angled front edges 601 and 602 can abut the enclosure to help align the pin 200 to keep it from spinning. Some embodiments utilize an even more pronounced triangle cross-section for the head portion 220.

In use, hinge pin 200 is placed within the bores of the aligned hinge sections until the protrusion 235 slips into slot 208. The hinge pin is removed by lifting up tab 502 and pushing up to remove the protrusion 235 from the slot. In some embodiments, bottom hinge section 136 can include slots also, and the hinge pin 200 can be inserted from the bottom or the top. As discussed above, the enclosure door can be made reversible if the enclosure includes additional hinges sections.

FIG. 7 shows a side view of a hinge pin 700, in accordance with one embodiment. FIG. 8 shows an end view of hinge pin 700. Hinge pin 700 includes similar features as discussed above for hinge pin 200 and the above discussion is incorporated herein by reference. In this example, hinge pin 700 generally includes a pin body 710 with a head portion 720 on one end. Head portion 720 includes a shoulder 725. A clip 730 is attached to hinge pin body 710 and extends from head portion 720 and includes a protrusion 735 on a free end of the clip 730.

Hinge pin body 710 is dimensioned to slidably fit within the bores of the hinge sections. In this embodiment, pin body 710 is generally straight. In other embodiments, pin body 710 can include a curvature, as discussed above. Also, in this example, head portion 720 includes a pronounced triangular cross-section shape including side walls 801, 802. Walls 801, 802 further help the hinge pin 710 from rotating when mounted within the hinge bores since the walls 801, 802 of the head portion align and abut against enclosure door to keep the pin from spinning.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A hinge pin usable with a hinge section having a bore, the hinge pin comprising:
a hinge pin body dimensioned to fit within a bore of a hinge section; and
a clip having a first end attached to the hinge pin body, the clip extending along the hinge pin body and configured to be located outside the hinge section when the hinge pin body is within the bore.

2. The hinge pin of claim 1, wherein the hinge pin body is curved along at least a portion of its length.

3. The hinge pin of claim 1, wherein a free end of the clip includes a protrusion.

4. The hinge pin of claim 3, wherein the free end of the clip includes a tab.

5. A hinge for an enclosure, the hinge comprising:
at least two hinge sections, each hinge section including a bore, at least one hinge section including a slot;
a hinge pin body dimensioned to slidably fit within the bores of the hinge sections; and
a clip attached to the hinge pin body, the clip including a protrusion so as to engage the slot in the hinge section when the hinge pin body is located within the hinge bores.

6. The hinge of claim 5, wherein the hinge pin body is curved along at least a portion of its length.

7. The hinge of claim 5, wherein the clip includes a first end attached to the hinge pin body, the clip extending along the hinge pin body and configured to be located outside the hinge section when the hinge pin body is within the bore.

8. The hinge of claim 5, wherein the free end of the clip includes a tab to raise the clip away from the hinge pin body.

9. An enclosure comprising:
an enclosure body including a hinge section including a first hinge bore;
a door mounted to the enclosure body, the door including a second hinge section including a second hinge bore, where the first hinge bore and the second hinge bore are substantially co-linear, and wherein at least one of the first bore or the second bore includes a slot; and
a removable hinge pin located within the first hinge bore and the second hinge bore, wherein the removable hinge pin includes a hinge pin body dimensioned to slidably fit within the hinge bores and a clip attached to the hinge pin body, the clip including a free end having a protrusion located to engage the slot when the hinge pin body is located within the hinge bores.

10. The enclosure of claim 9, wherein the hinge pin body is curved along at least a portion of its length.

11. The enclosure of claim 9, wherein the free end of the clip includes a tab to raise the clip away from the hinge pin body.

12. The enclosure of claim 9, wherein a cross-section of a head portion of the clip includes at least two surfaces angled relative to each other.

13. A method comprising:
aligning a first hinge section having a bore and a second hinge section having a second bore;
sliding a hinge pin body into the first and second bores; and
sliding a clip attached to the hinge pin body over the outside of at least the first hinge section.

14. The method of claim 13, wherein the first hinge section includes a slot and the clip includes a protrusion and the protrusion is engaged with the slot.

15. The method of claim 13, wherein the hinge pin body is curved along its length.
